(19) United States
(12) Patent Application Publication
(10) Pub. No.: US 2026/0045711 A1
(43) Pub. Date: Feb. 12, 2026

(54) CONNECTION TERMINAL FOR CONNECTING AN ELECTRICAL WIRE

(71) Applicant: PHOENIX CONTACT GMBH & CO. KG, Blomberg (DE)

(72) Inventors: Dennis GEISLER, Extertal (DE); Arndt SCHAFMEISTER, Dörentrup (DE)

(21) Appl. No.: 19/104,232

(22) PCT Filed: Aug. 7, 2023
(86) PCT No.: PCT/EP2023/071786

§ 371 Date: Feb. 17, 2025

(30) Foreign Application Priority Data
Aug. 18, 2022 (LU) LU502683

(51) Int. Cl. H01R 9/24; H01R 4/48

(52) U.S. Cl. CPC H01R 9/2416; H01R 4/4821; H01R 4/483; H01R 4/4835; H01R 9/2491

(57) ABSTRACT

A connection terminal for connecting an electrical wire includes: a housing part; a contact element arranged on the housing part, the contact element having a contact portion for electrically contacting the electrical wire; a spring element having has a clamping leg that is adjustable relative to the housing part, the clamping leg acting on the electrical wire in a clamping position for contact with the contact portion; and an actuation element arranged on the housing part so as to be pivotable about a pivot axis, the actuation element being pivotable from an unactuated position into an actuated position so as to adjust the clamping leg from the clamping position. The actuation element has a first sliding face formed on a body portion of the actuation element. The housing part has a second sliding face formed on a housing portion.

### CROSS-REFERENCE TO PRIOR APPLICATIONS

This application is a U.S. National Phase application under 35 U.S. C. § 371 of International Application No. PCT/EP2023/071786, filed on Aug. 7, 2023, and claims benefit to Luxembourgish Patent Application No. LU 502683, filed on Aug. 18, 2022. The International Application was published in German on Feb. 22, 2024 as WO 2024/037909 A1 under PCT Article 21(2).

### FIELD

The invention relates to a connection terminal for connecting an electrical wire.

### BACKGROUND

Such a connection terminal has a housing part, a contact element arranged on the housing part with a contact portion for electrically contacting an electrical wire, and a spring element with a clamping leg that can be adjusted relative to the housing part. The clamping leg of the spring element is designed to act upon an electrical wire in a clamping position for contacting the contact portion. An actuation element is arranged on the housing part so as to be pivotable about a pivot axis and can be pivoted from an unactuated position to an actuated position, in order to adjust the clamping leg from the clamping position By using the spring element, the connection terminal establishes a spring force connection in which, in the connected position, the electrical wire is clamped to the contact element under the elastic action of the spring element and is thus electrically connected to the contact element.

In a connection terminal known from DE 10 2019 127 464 B3, a spring element in the form of a tension spring is provided, which pulls a connected electrical wire into abutment with an associated contact element by the resilient action of the spring and thus establishes a clamping connection between the electrical wire and the contact element. For this purpose, when attaching the electrical wire, it is pushed through an opening in the clamping leg and is clamped between the clamping leg and the contact element when in the connected position.

The connection terminal in DE 10 2019 127 464 B3 provides a locking device used to lock the clamping leg in a release position relative to the housing. When the electrical wire is inserted, the locking device is detached and the locking engagement is therefore released such that clamping leg is moved from the release position, and the electrical wire is thereby clamped to the contact element. In order to move the clamping leg into the release position, in particular to enable the electrical wire to be attached or to detach a connected electrical wire from the connection terminal, a tool, e.g., a screwdriver, can be attached to the connection terminal, and a force can thereby be exerted on the clamping leg.

While in DE 10 2019 127 464 B3, the clamping leg is directly moved by means of a tool, in each of the connection terminals known from DE 10 2019 135 203 A1 and DE 10 2020 104 140 A1, an actuation element in the form of a so-called pusher is provided which can be pushed into the housing of the connection terminal in order to thereby act upon the clamping leg and to transfer the clamping leg into its release position. The actuation element is spring-loaded relative to the housing of the connection terminal via a clamping spring in the form of a compression spring. In the connection terminal known from DE 10 2019 135 203 A1, an actuating lug is arranged on the actuation element, which hooks into a fastening portion of a retaining element when the actuation element is in the actuated position.

### SUMMARY

In an embodiment, the present invention provides a connection terminal for connecting an electrical wire, comprising: a housing part; a contact element arranged on the housing part, the contact element having a contact portion configured to electrically contact the electrical wire; a spring element having has a clamping leg that is adjustable relative to the housing part, the clamping leg being configured to act on the electrical wire in a clamping position for contact with the contact portion; and an actuation element arranged on the housing part so as to be pivotable about a pivot axis, the actuation element being pivotable from an unactuated position into an actuated position so as to adjust the clamping leg from the clamping position, wherein the actuation element has a first sliding face formed on a body portion of the actuation element, and wherein the housing part has a second sliding face formed on a housing portion, the second sliding face being configured to slidingly support the first sliding face upon pivoting of the actuation element about the pivot axis.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a view of a connection assembly with a plurality of connection terminals accommodated in an outer housing;

FIG. 2 shows a side view of the connection assembly;

FIG. 3 shows the connection assembly according to FIG. 1 in an actuated position of actuation elements of the connection terminals;

FIG. 4 shows a side view of the connection assembly according to FIG. 3;

FIG. 5 shows a longitudinal sectional view through a connection terminal, in an actuated position of an actuation element;

FIG. 6 shows a side view of the connection terminal;

FIGS. 7A-7C show separate views of a detachment element of the connection terminal;

FIG. 8A shows a view of a housing part of the connection terminal;

FIG. 8B shows another view of the housing part;

FIGS. 9A-9D show separate views of the actuation element;

FIG. 10 shows a front view of a housing part; and

FIG. 11 shows a sectional view along the line I-I according to FIG. 2.

In an embodiment, the present invention provides a connection terminal in which a comfortable actuation via the actuation element is possible, with smooth, reliable mounting of the actuation element relative to the housing part of the connection terminal.

Therefore, the actuation element has a first sliding face formed on a body portion of the actuation element and the housing part has a second sliding face formed on a housing portion for slidingly supporting the first sliding face when the actuation element pivots about the pivot axis.

The connection terminal comprises a housing part on which a spring element is arranged. The spring element has a clamping leg which is designed to act in a clamping manner on an electrical wire connected to the connection terminal in order to clamp it to a contact portion of a contact element and thereby electrically connect the electrical wire with a stripped conductor end to the contact element.

The clamping leg can be elastically adjusted relative to the housing part in order to move the clamping leg out of the clamping position. In particular, the clamping leg can be moved into a release position in order to remove the clamping leg from the contact portion of the contact element and thus to enable a simple, substantially forceless connection of an electrical wire or to be able to remove a connected electrical wire from the connection terminal in a simple, forceless manner.

To move the clamping leg relative to the housing part, an actuation element is pivotably arranged on the housing part. The actuation element can be pivoted about a pivot axis relative to the housing part and acts on the clamping leg, in particular to adjust it out of the clamping position and thus to move it elastically relative to the housing part.

In the case of an actuation element pivotably mounted on a housing part for adjusting the clamping leg, loading forces on the actuation element act not only in tension and compression (as is usually the case with an actuation element displaceably mounted on the housing), but also as a bending load, in particular about a bending axis perpendicular to the pivot axis. In order to provide a support for the actuation element for pivotable mounting on the housing part for this purpose, the actuation element has a first sliding face, which is formed on a body portion and which is designed to cooperate with a complementary sliding face on a housing portion of the housing part in order to create a support between the actuation element and the housing part when the actuation element is pivoted.

The first sliding face and the second sliding face are radially spaced from the pivot axis. For example, the first sliding face can be formed on an outer, radially outward-facing wall of the actuation element in order to cooperate in a sliding manner with the sliding face on the housing portion of the housing part.

In this case, it can be provided that the first sliding face and the second sliding face are always in sliding contact with one another when the actuation element is pivoted, so that a sliding bearing exists between the sliding faces.

In another embodiment, it can also be provided that the first sliding face only comes into contact with the second sliding face on the housing portion of the housing part when there is an (excessive) load on the actuation element, for example when there is a compressive effect on an actuating portion along a direction perpendicular to the pivot axis.

In this design, the sliding faces are therefore not always in contact with one another, but only come into sliding contact with one another when there is an (excessive) load on the actuation element.

In one embodiment, the first sliding face and/or the second sliding face are curved about the pivot axis. The first sliding face and/or the second sliding face can, for example, have a constant radius of curvature around the pivot axis so that the first sliding face and/or the second sliding face extend in an arc with a constant radius around the pivot axis.

Preferably, both the first sliding face and the second sliding face are curved about the pivot axis and have an arc shape with a constant radius of curvature to the pivot axis. The sliding faces are shaped complementarily to one another, in that the first sliding face on the actuation element has a convex shape and the second sliding face on the housing portion has a complementary, concave shape.

However, it is also conceivable that only one of the sliding faces is curved and rests on the other sliding face at one or more contact points.

In one embodiment, the actuation element has an actuating portion for actuation by a user and an active portion for acting on the clamping leg. While the actuating portion is accessible from outside the housing part, e.g., by a user being able to act upon the actuating portion using a tool, such as a screwdriver, or, alternatively, manually, the active portion is operatively connected to the clamping leg of the spring element. By moving the actuation element, a movement force is exerted on the clamping leg via the active portion such that, in particular when the actuation element is moved from the unactuated position into the actuated position, the clamping leg is entrained and is thus moved in the direction of a release position.

In one embodiment, the body portion of the actuation element on which the first sliding face is formed forms the active portion for acting on the clamping leg when the actuation element is pivoted. With the body portion forming the active portion, which integrally and in one piece also forms the (first) sliding face on the actuation element, the actuation element acts on the clamping leg of the spring element when pivoting from the unactuated position into the actuated position and adjusts it in the direction of a release position. The body portion on which the sliding face of the actuation element is formed is formed by the active portion, so that the actuation element is slidingly supported on the housing portion of the housing part via a surface of the active portion when the actuation element is pivoted about the pivot axis relative to the housing part.

Preferably, the first sliding face rests against the second sliding face in the unactuated position and in the actuated position of the actuation element and when the actuation element pivots about the pivot axis between the unactuated position and the actuated position. The first sliding face and the second sliding face are thus in contact with one another in a supporting manner both in the unactuated position and in the actuated position and also during a movement in between. In particular, due to the support in the actuated position, forces can be absorbed and supported on the actuation element when the clamping leg is deflected, without the force of the clamping leg causing any (significant) deformation of the actuation element.

In one embodiment, the actuation element has a further, second body portion. The clamping leg is, for example, received in a receiving slot between the (first) body portion, on which the first sliding face is formed, and the further, second body portion. The clamping leg is thus supported in a defined position on the actuation element, wherein when the actuation element is pivoted about the pivot axis, the clamping leg is pivoted together with the actuation element relative to the housing and is thus moved in the direction of a release position.

For example, the first sliding face is formed on an outer side of the body portion pointing radially outward to the pivot axis. The first sliding face is thus formed on an outer surface of the actuation element and faces radially outward in order to be slidingly supported on the second sliding face of the housing portion of the housing part.

In one embodiment, the first sliding face is arranged on a side of the clamping leg facing away from the pivot axis. The clamping leg is thus spatially received on the actuation element in a region between the first sliding face and the pivot axis. For example, the clamping leg can extend approximately transversely to a (imaginary) line between the first sliding face and the pivot axis and thus extends between the first sliding face and the pivot axis. The clamping leg is thus supported on the actuation element radially within the first sliding face. The first sliding face for sliding support relative to the housing during pivoting is thus located at a radially outer position compared to the clamping leg so that reliable support and dissipation of a bending load on the actuation element can be ensured.

In one embodiment, the housing portion of the housing part forms an insertion opening for inserting an electrical wire. On the housing portion, the second sliding face is formed on the side of the housing part in order to provide a sliding support for the actuation element during pivoting relative to the housing part.

The actuation element is preferably pivotably mounted on the housing via the first and second sliding faces in addition to the sliding bearing. For example, an axle element can be formed on the actuation element or on the housing part, which is concentric with the pivot axis and via which the actuation element is pivotably mounted on the housing part. The axle element is arranged radially inside the first sliding face.

For example, the sliding element can be mounted on the housing part on only one side (with respect to the pivot axis) via an axle element.

The connection terminal can, for example, be part of a connection assembly with a plurality of connection terminals arranged in a row along a row direction.

In one embodiment, the spring element of the connection terminal is designed as a tension spring. In this case, the clamping leg of the spring element is designed to pull the electrical wire into abutment with the contact element by spring force. In this case, for example, an opening can be formed in the clamping leg through which the electrical wire can be guided, when it is plugged into the connection terminal, in order to pull the electrical wire into clamping contact with the contact element after the clamping leg has been detached from the release position.

Alternatively, the spring element of the connection terminal can be designed as a compression spring. In this case, the clamping leg is designed to push the electrical wire into abutment with the contact element by spring force. When plugged into the connection terminal, the electrical wire enters a space between the clamping leg and the contact element, wherein, after the clamping leg has been detached from the release position, the clamping leg acts upon the electrical wire and pushes it into abutment with the contact element.

The spring element of the connection terminal can, for example, have a supporting leg via which the spring element is supported on the housing part and held in position on the housing part. The clamping leg can be elastically deflected relative to the supporting leg, wherein, in the release position, the clamping leg is deflected such that the spring element is elastically loaded, and the clamping leg is moved out of the release position under elastic preload after being detached from the release position.

The supporting leg can, for example, rest against a supporting portion of the housing part and is thereby supported on the housing part. The spring element is thus attached to the housing part independently of the contact element and is therefore not directly electrically connected to the contact element if the housing part is made of an electrically insulating material, in particular a plastic material.

In one embodiment, the spring element has a curved connecting portion arranged between the clamping leg and the support leg, which connecting portion extends around the pivot axis. The support leg and the clamping leg preferably protrude from the actuation element and are arranged at an (acute) angle to each other, wherein the clamping leg can be elastically adjusted relative to the support leg. Since the connecting portion extends around the pivot axis, a pivot point can be defined for the clamping leg and is preferably concentric with the pivot axis of the actuation element, so that when the actuation element is pivoted, the clamping leg is supported in a fixed position on the actuation element and is pivoted together with the actuation element about the pivot axis assigned to the actuation element and is thereby deflected relative to the support leg.

In one embodiment, the supporting leg of the spring element is supported on the housing part associated with the connection terminal and on the housing part of a connection terminal that is adjacent along the row direction. The supporting leg is thus supported on the housing part of the associated connection terminal and rests, for example, on a supporting portion on a wall of the housing part. In addition, the supporting leg is also supported on the housing part of an adjacent connection terminal and, for example, rests on a supporting portion on a wall of the adjacent housing part. The supporting leg is thus supported jointly on two housing parts of adjacent connection terminals.

The electrical wire in the connection terminal is electrically contacted by the electrical contact element by the clamping leg acting upon the electrical wire when said electrical wire is plugged into the connection terminal and applying an elastic load thereto in the direction of contact with the contact element. To make it easier to attach the electrical wire, the clamping leg of the spring element can be elastically deflected, e.g., using a tool or by actuating an actuation element, in order to thereby move the clamping leg into a release position in which a space in the region of an insertion opening is cleared, and the electrical wire can accordingly be inserted into the insertion opening substantially without any force, or a connected electrical wire can be easily removed from the connection terminal.

Once the clamping leg has been moved into the open position, the clamping leg, in one embodiment, is retained in the open position relative to the housing part. This can be done by directly locking the clamping leg relative to the housing part or by indirect locking-for example, via an actuation element.

In one embodiment, the connection terminal has a detachment element which is designed to interact with the electrical wire when plugged into the connection terminal to detach the clamping leg from the release position. In so doing, the detachment element also serves to detach the clamping leg from the release position in order to automatically release the clamping leg from the release position when the electrical wire is inserted and thus to transfer the clamping leg into a clamping position in which the electrical wire inserted into the insertion opening is electrically contacted by the contact element of the connection terminal. Since the detachment element is deflected when the electrical wire is inserted, the connection terminal closes automatically when the electrical wire is inserted. This results in a simple connection process, with reliable contacting of the wire with the contact element.

Such a connection terminal, in which the clamping leg of the spring element is held in position relative to the housing part in the release position and which can be automatically detached via a detachment element when an electrical wire is inserted, can be delivered by a manufacturer with the clamping leg in the release position, for example.

In one embodiment, the detachment element comprises a detachment leg which is designed to interact with the electrical wire when plugged into the connection terminal. By interacting with the electrical wire, the detachment leg is detached, so that the clamping leg is released from the release position. The housing part defines a receiving space into which the electrical wire can be introduced by inserting it into an insertion opening. The detachment leg extends into the receiving space to interact with the electrical wire. In particular, the electrical wire can be inserted into the insertion opening along an insertion direction, wherein the detachment leg extends with an end portion (approximately) transversely to the insertion direction within the receiving space.

The detachment element can, for example, be designed as an integral, inherently elastically springy element.

In one embodiment, the detachment element has a support end, relative to which the detachment leg is elastically adjustable by interaction with the wire connected to the connection terminal. The detachment element is supported on the housing part via the support end-for example, by the support end being fastened to an associated connecting device of the housing part of the connection terminal. The detachment element is thus fastened to the housing part via the supporting end by the supporting end being operatively connected to a connecting device of the housing part, and is thereabove held on the housing part in a torque-tight manner.

The support end is preferably fixed in a torque-tight manner to the connecting device of the housing part of the connection terminal. The supporting end can extend flat, which has the advantage that a contour can be formed at the supporting end in a simple manner, e.g., by punching, via which contour it can be reliably, e.g., form-fittingly, fixed to the connecting device of the housing part. While the supporting end is supported in a torque-tight manner relative to the housing part, the detachment leg can be elastically moved in the receiving space and extends in the receiving space in such a way that an electrical wire inserted into the connection terminal strikes the detachment leg when introduced into the receiving space and thus deflects it.

In one embodiment, the support end of the detachment element of the connection terminal is supported on the housing part assigned to the connection terminal and the housing part of a connection terminal adjacent along the row direction. The support end is thus supported on the housing part of the associated connection terminal and, for example, engages in an engagement opening on a wall of the housing part. In addition, the support end is also supported on the housing part of an adjacent connection terminal and, for example, engages in an engagement opening on a wall of the adjacent housing part. The support end is thus supported jointly on two housing parts of adjacent connection terminals.

In one embodiment, the actuation element locks into the actuated position with the detachment element of the connection terminal. In the actuated position, the actuation element is accordingly held in position by the detachment element such that the clamping leg of the spring element is thereabove also held in its release position in which it is possible to easily attach an electrical wire to the connection terminal or to remove a connected wire from the connection terminal substantially without any force. After releasing the locking engagement, the actuation element can move back, in particular automatically, towards the unactuated position, preferably under spring preload. The actuation element can be subjected to spring preload, for example, by the clamping leg, which is elastically deflected in the actuated position and, after the actuation element has been released, acts upon the actuation element in a resiliently mechanical manner to transfer the actuation element from the actuated position towards the unactuated position.

In one embodiment, the actuation element has a locking portion for engaging with a locking device of the detachment element of the connection terminal when in the actuated position. The locking portion can, for example, be arranged on a side, facing away from the actuating portion, of the actuation element (with respect to the pivot axis of the pivotable bearing for the actuation element on the housing part), preferably approximately diametrically remote from the actuating portion with respect to the pivot axis. By means of the locking portion, the actuation element is locked in the actuated position by an associated locking device of the detachment element such that the actuation element is thereabove held in the actuated position, but can be detached from the actuated position in a simple and reliable manner by detaching the detachment leg when the electrical wire is inserted.

The locking device of the detachment element can be formed, for example, by an opening in which the locking portion of the actuation element, e.g., formed by a projection, engages when the actuation element is in the actuated position. The actuation element is thus held in position in its actuated position by the form-fitting engagement of the locking portion in the opening of the detachment element, wherein the engagement can be released by adjusting the detachment leg, and the actuation element can thus be detached from the actuated position to transfer the clamping leg into the release position.

In one embodiment, the actuation element of the connection terminal is mounted on the housing part associated with the connection terminal and the housing part of a connection terminal adjacent along the row direction. Housing parts of adjacent connection terminals thus jointly support the actuation element between them. For example, each housing part can have a shaft journal that engages in a bearing opening on the actuation element, so that thereabove a pivot bearing for the actuation element is provided between the housing parts.

In one embodiment, a connection assembly has a plurality of connection terminals which are designed in the manner described above. The housing parts of the connection terminals are arranged in a row along a row direction. The connection assembly has an outer housing into which the housing parts, arranged in a row along the row direction, of the connection terminals can be inserted in an assembly direction. The connection assembly is created by attaching the housing parts of the connection terminals to one another along a row direction. In a position arranged in a row, the housing parts can be inserted into the outer housing of the connection assembly, so that, in an assembled position, the housing parts are received in the outer housing and are thus enclosed by the outer housing.

The outer housing can, for example, have a box shape that is open on one side, so that the housing parts arranged in a row can be inserted into the box-shaped outer housing. In another embodiment, the outer housing can, for example, have the shape of a frame that is open on two sides and into which the housing parts arranged in a row can be inserted.

By providing the outer housing, the advantages of a disk design of the connection terminals and a so-called monoblock are combined.

Because the connection terminals are designed with individual housing parts and can be attached to one another along the row direction to create the connection assembly, the housing parts can be designed in such a way that the components of the connection terminals can be easily mounted on the corresponding housing part-for example, the spring element and the contact element. For example, the housing part of each connection terminal is not closed on the outside; rather, the housing of the connection terminals is completed only by attaching the housing parts of the connection terminals to one another. This results in simple assembly of the individual connection terminals and an ability to be combined in a variable manner with other connection terminals.

The fact that the connection terminals arranged in a row are enclosed in the outer housing in the assembled position also creates a mechanically stable assembly in which the housing parts of the connection terminals in the position in a row are accommodated in the housing and fixed to the housing in a defined manner.

The row direction and the assembly direction are preferably perpendicular to each other. The (disk-shaped) connection terminals are attached to one another along the row direction by arranging the housing parts in a row along the row direction. In a position arranged in a row, the housing parts are pushed into the outer housing in the assembly direction perpendicular to the row direction, so that, in the assembled position, the housing parts are enclosed in the outer housing.

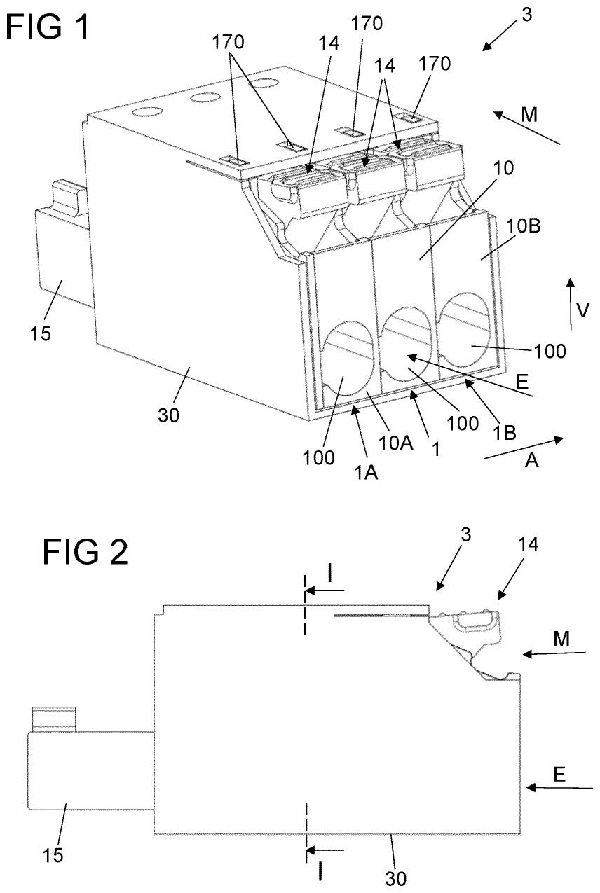

FIG. 1 to 4 show an exemplary embodiment of a connection assembly 3 which has a plurality of connection terminals 1, 1A, 1B which are jointly enclosed by an outer housing 30. The connection terminals 1, 1A, 1B are arranged in a row in a row direction A and are jointly enclosed by the outer housing 30, wherein each connection terminal 1, 1A, 1B is assigned an insertion opening 100 in a correspondingly associated housing part 10, 10A, 10B, into which an electrical wire 2 can be inserted in an insertion direction E by means of a (stripped) conductor end 20 in order to connect the electrical wire 2 to the connection terminal 1, 1A, 1B.

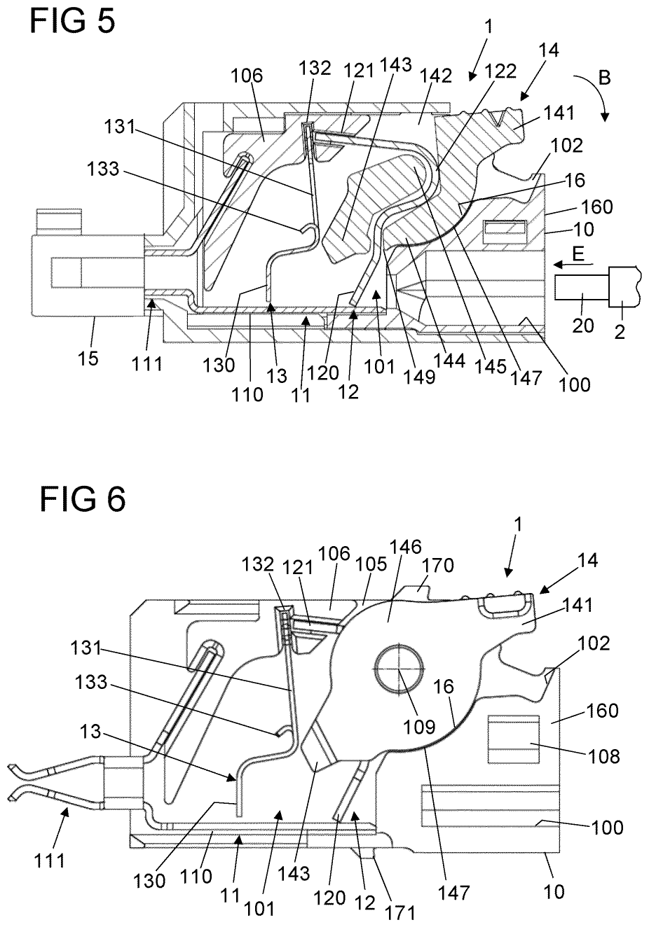

FIGS. 5 and 6 show an exemplary embodiment of an individual connection terminal 1 which has a housing part 10 with an insertion opening 100 formed on a housing portion 160 for inserting an electrical wire 2 in an insertion direction E. The other connection terminals 1A, 1B can be identical in construction and function to connection terminal 1, so that the following explanations apply to all connection terminals 1, 1A, 1B.

However, it is also conceivable for the connection terminals 1, 1A, 1B to differ in their functionality and in particular to not have all of the components described below.

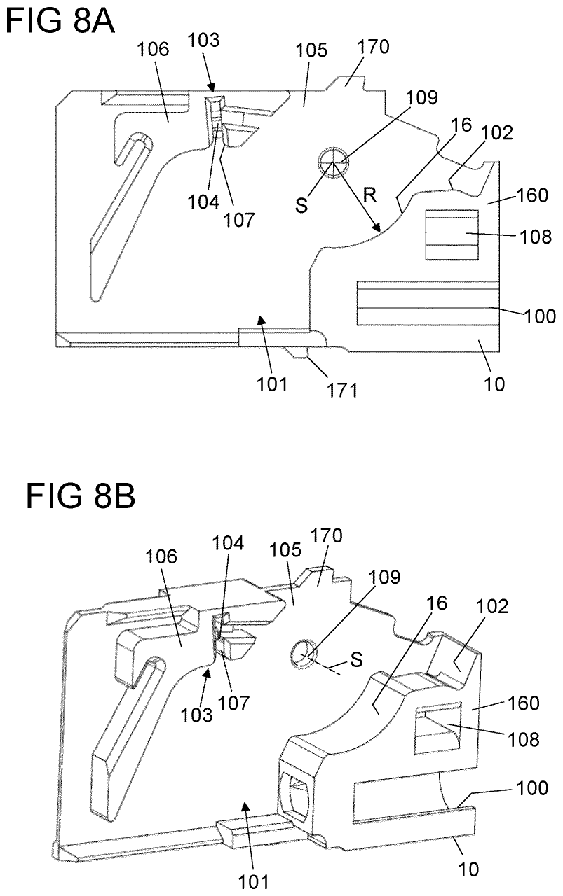

The housing part 10 of a (each) connection terminal 1, 1A, 1B shown in separate views in FIGS. 8A and 8B defines a receiving space 101 into which the electrical wire 2 is introduced by means of a stripped conductor end 20 when it is inserted into the insertion opening 100 in the insertion direction E. In a connected position, the wire 2 with the stripped conductor end 20 is located within the receiving space 101 and is electrically contacted via a clamping leg 120 of a spring element 12 by a contact element 11 in the form of a current bar such that the electrical wire 2 is electrically connected to the connection terminal 1.

The spring element 12 has a supporting leg 121 which is supported on a wall 106 of the housing 10. The clamping leg 120 can be elastically deflected relative to the supporting leg 121, in particular such that the clamping leg 120 clamps, in a clamping position, an electrical wire 2 connected to the connection terminal 1 and pushes this under elastic preload into contact with the contact element 11, and thus brings the wire 2 into electrical contact with the contact element 11 via its conductor end 20.

The contact element 11 has a contact portion 110 which extends in the housing part 10 in a planar manner and against which the conductor end 20 of the electrical wire 2 is pressed by spring preload of the clamping leg 120 when the electrical wire 2 is connected to the connection terminal 1. The contact portion 110 is connected to a contacting device 111 arranged in a plug connector portion 15, via which contacting device the connection terminal 1 can be plugged into an associated mating electrical connector.

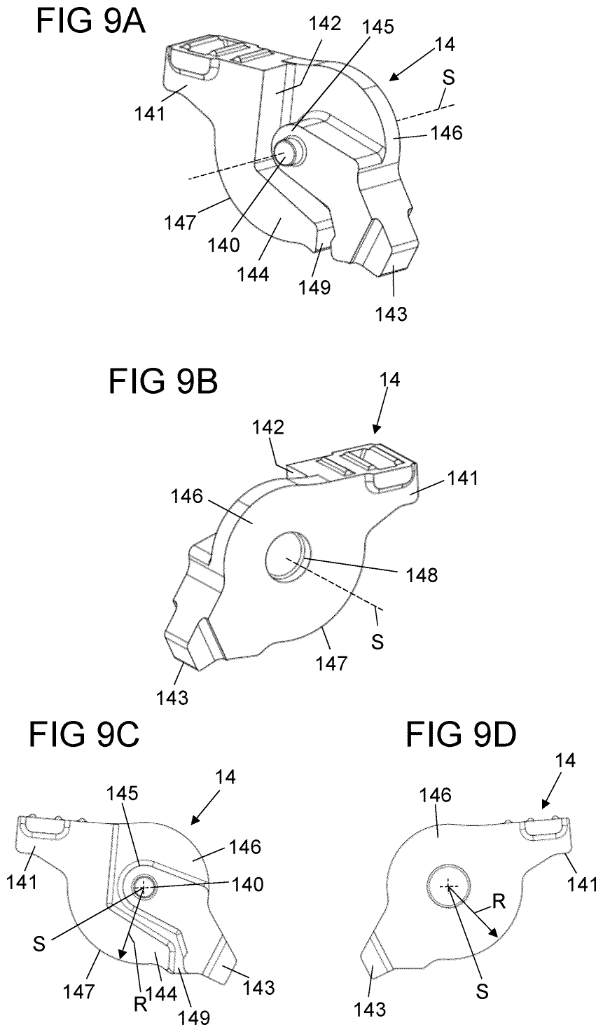

In the exemplary embodiment shown, an actuation element 14 shown in separate views in FIGS. 9A-9D is mounted on the housing part 10 of the connection terminal 1 so as to be pivotable about a pivot axis S. The actuation element 14 can be pivoted around the pivot axis S relative to the housing part 10, wherein an actuating portion 141 is accessible from outside the housing part 10 via an actuating opening 102 and can thus be actuated by a user—for example, using a tool.

As can be seen from the separate views according to FIG. 9A-9D, the actuation element 14 has a body portion 144 which forms an active portion for acting on the clamping leg 120. The body portion 144, together with a body portion 145, forms a receiving slot 149 in which the clamping leg 120 is inserted such that the spring element 12 is extended around the pivot axis S with a curved intermediate portion 122 arranged between the clamping leg 120 and the support leg 121, so that a pivot point for deflecting the clamping leg 120 is concentric with the pivot axis S.

The body portions 144, 145 are raised relative to a rear wall 146 of the actuation element 14. The support leg 122 protrudes from the actuation element 14 in the region of an opening 142 and is supported on the housing part 10, as can be seen from the sectional view according to FIG. 5. Since the clamping leg 120 is received in the receiving slot 149, when the actuation element 14 is pivoted, an actuating force is introduced into the clamping leg 120 via the active portion 144, so that the clamping leg 120 is elastically deflected about the pivot point concentric with the pivot axis S relative to the support leg 121 and is moved in the direction of a release position.

The actuation element 14 has an axle element 140 formed on the body portion 145, which axle element engages in a bearing opening 109 on a wall 105 of the housing part 10, as can be seen from FIG. 9A in conjunction with FIGS. 8A and 8B. The actuation element 14 is pivotably mounted about the pivot axis S relative to the housing part 10 via the axle element 140.

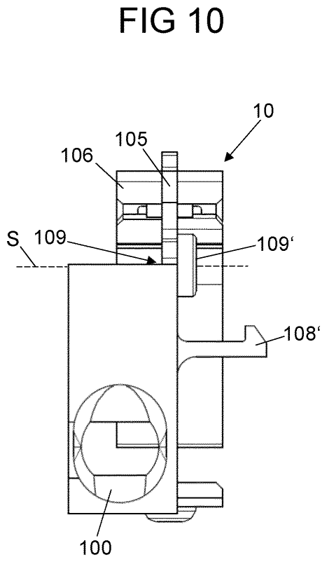

In the illustrated embodiment of the actuation element 14, a recess 148 is formed on a rear side of the rear wall 146, into which recess an axle element 109′of an adjacent housing part engages, as follows from the front view of the housing part 10 according to FIG. 10.

On the outside of the body portion 144 forming the active portion, a first sliding face 147 is formed which is curved about the pivot axis S and has a constant radius of curvature R with respect to the pivot axis S, as can be seen from FIG. 9D. The sliding face 147 faces an associated second sliding face 16 on the housing portion 160 of the housing part 10, which is shaped complementarily to the first sliding face 147 and has a constant radius of curvature R to the pivot axis S, as can be seen from FIG. 8A.

When the actuation element 14 is pivoted, the sliding faces 147, 16 are slidingly supported against one another. The sliding face 16 is located on the housing portion 160 of the housing part 10, on which the insertion opening 100 is also formed, wherein the sliding face 16 is formed above the insertion opening 100 on a side of the housing portion 160 facing the actuation element 14.

Since the sliding face 147 is formed on an outer side of the body portion 144, which forms the active portion for acting on the clamping leg 120, the sliding support via the sliding faces 147, 16 takes place on a comparatively large radius R with respect to the pivot axis S and thus at a position radially distant from the pivot axis S. Bending loads which act upon pressure on the actuating portion 141 for actuating the actuation element 14 can thus be absorbed by the sliding support of the sliding faces 147, 16 on one another, so that excessive stress on the actuation element 14, in particular on the axle element 140, is avoided.

The connection terminal 1 has a detachment element 13 which is fastened to the housing 10 via a supporting end 132 and is thereby supported in a torque-tight manner relative to the housing part 10. A detachment leg 130 extends from the supporting end 132 and projects into the receiving space 101 substantially transversely to the insertion direction E and thus extends in a region aligned with the insertion opening 100.

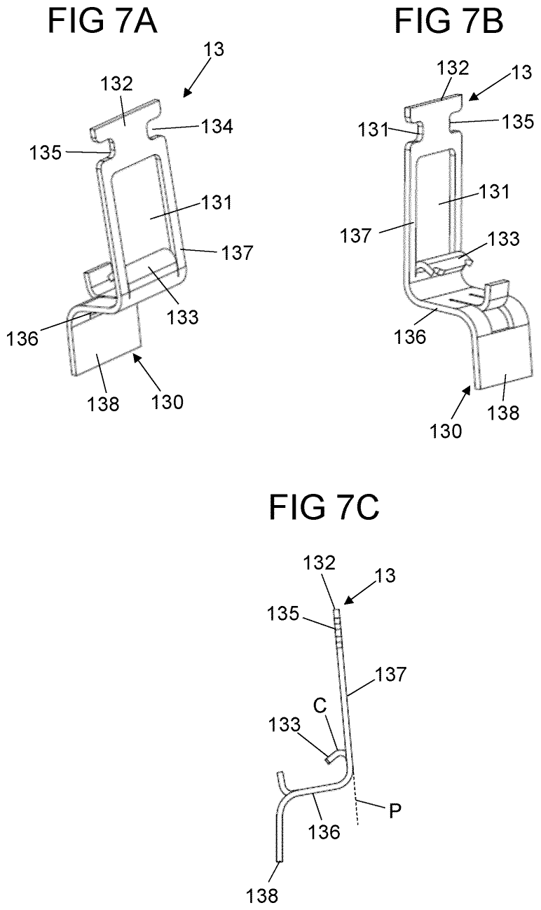

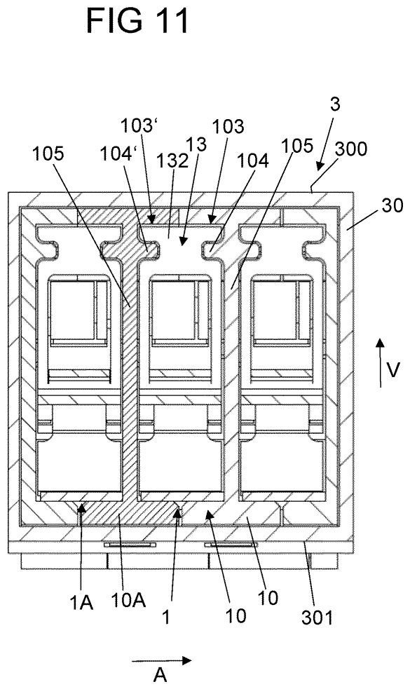

As can be seen from the separate view of the detachment element 13 according to FIGS. 7A-7C, the detail views of the housing part 10 according to FIGS. 8A, 8B, and the sectional view according to FIG. 11, the supporting end 132 of the detachment element 13 is form-fittingly connected to connecting devices 103, 103′of adjacent housing parts 10, 10A. The supporting end 132 of the detachment element 13 formed by a strip-shaped spring element has recesses 134, 135 in its opposite lateral edges, which, in the mounted position of the detachment element 13, engage with form-fitting elements 104, 104′on the connecting devices 103, 103′.

The connecting devices 103, 103′are each formed by an engagement opening 107 into which the supporting end 132 engages such that the supporting end 132 is form-fittingly received on the housing part 10. The supporting end 132 is form-fittingly connected to the housing part 10 such that the supporting end 132 cannot slide out of the connecting devices 103, 103′and, in addition, the supporting end 132 is supported on the housing part 10 in such a way that, when the detachment leg 130 is elastically deflected, torques can be absorbed at the supporting end 132 and diverted into the housing part 10, while the supporting end 132 remains in position relative to the housing part 10.

The engagement opening 107 is formed in a wall portion 106 of each housing part 10, 10A, which protrudes from a planar side wall 105 of the housing part 10, 10A, as can be seen from FIGS. 5, 6 and 8A, 8B.

The detachment leg 130 serves to interact with an electrical wire 2 inserted into the insertion opening 100, in particular to automatically connect the electrical wire 2 to the connection terminal 1 by detaching the clamping leg 120.

The detachment element 13 has an opening 131 with which the actuation element 14 engages via a locking portion 143 in the form of a projection when the actuation element 14 has been transferred into an actuated position in an actuating direction B. In the actuated position, the actuation element 14 engages in the opening 131 by means of the locking portion 143 and is thereabove held, so as to be locked, on the detachment leg 130, so that the actuation element 14 is locked in the actuated position.

In the illustrated exemplary embodiment, the detachment leg 130 is bent. Between a free end 138 of the detachment leg 130 remote from the supporting end 132 and a leg portion 137 of the detachment leg 130 aligned with the supporting end 132 and in which the opening 131 is formed, an intermediate portion 136 extends transversely between the free end 138 of the detachment leg 130 and the leg portion 137 of the detachment leg 130 bearing the opening 131. By suitably shaping the detachment element 13, the detachment element 13 can be adapted to the installation space conditions within the receiving space 101 of the housing 10.

If the actuation element 14 is actuated in the actuating direction B and thereby pivoted around the pivot axis 140 relative to the housing part 10 into the actuated position, the actuation element 14 entrains the clamping leg 120 of the spring element 12 via the active portion 144 and thereby moves the clamping leg 120 into a release position. In the release position, the free end of the clamping leg 120 is removed from the contact portion 110 of the contact element 11 and thus releases a region, aligned with the insertion opening 100 in the insertion direction E, within the receiving space 101 such that an electrical wire 2 can be inserted into the insertion opening 100, unhindered by the clamping leg 120, and thus connected to the connection terminal 1 substantially without any force.

If an electrical wire 2 with a stripped conductor end 20 is inserted into the insertion opening 100 and thereby introduced into the receiving space 101 in the insertion direction E while the actuation element 14 is in the actuated position and thus the clamping leg 120 is in the release position, the wire 2 comes into abutment with the end portion 138 of the detachment leg 130 of the detachment element 13 and elastically deflects it relative to the supporting end 132 and thus to the housing part 10. As a result, the detachment leg 130 is moved in the insertion direction E relative to the locking portion 143 of the actuation element 14 so that the locking portion 143 disengages from the opening 131, and thus the actuation element 14 is released from the actuated position.

On a side, facing the free end 138 of the detachment leg 130, of the opening 131, a run-on element 133 is formed by a bent portion of the detachment element 13, formed as a sheet metal element, against which the locking portion 143 rests in the locking position and onto which the locking portion 143 runs when the locking engagement is detached.

Since the electrical wire 2 acts upon the detachment leg 130 with a lever arm that is larger than the lever arm acting upon the locking portion 143, the detachment leg 130 can be deflected with little force, to be applied by the electrical wire 2, and thus the locking engagement can be released easily and reliably when the electrical wire 2 is inserted.

After the locking engagement is released when an electrical wire 2 is inserted, the actuation element 14 moves out of the actuated position due to the elastic preload on the clamping leg 120 and is returned counter to the actuation direction B. The clamping leg 120 comes into clamping abutment with the electrical wire 2 and thereby pushes the conductor end 20 into contacting abutment with the contact element 11 so that the wire 2 is electrically connected to the connection terminal 1 and is also mechanically locked.

Since the actuation element 14 is moved out of the actuated position after the locking engagement is detached, a user can safely and reliably detect that the connection terminal 1 has been detached, and the electrical wire 2 is thus connected to the connection terminal 1. The risk of incorrect operation is thus reduced.

If the electrical wire 2 is to be detached from the connected position and again removed from the connection terminal 1, the actuation element 14 can be transferred back into the actuated position so that the clamping leg 120 is not in abutment with the wire 2. The wire 2 can thus be removed from the connection terminal 1 substantially without any force.

The connection terminal 1 or the connection assembly 3 of all connection terminals 1, 1A, 1B can, for example, be delivered with the actuation element 14 (in each case) actuated. In the actuated position, the actuation element 14 is locked to the detachment element 13 of the connection terminal 1, 1A, 1B, wherein the actuation element 14 is kept under tension due to the tension on the spring element 12. Bending loads are absorbed and supported by the support of the sliding faces 147, 16, so that excessive bending stress in the region of the axle element 140 is avoided.

In addition, even when a force is introduced into the actuating portion 141, for example manually or by a tool for actuating the actuation element 14, a bending load is supported on one another via the sliding support of the sliding faces 147, 16.

In the illustrated exemplary embodiment, the housing parts 10, 10A, 10B of the connection terminals 1, 1A, 1B are attached to one another along the alignment direction A. The housing part 10, 10A, 10B of a connection terminal 1, 1A, 1B is completed by the housing part 10, 10A, 10B of the adjacent connection terminal, so that the housing parts 10, 10A, 10B together form a housing for the connection terminals 1, 1A, 1B.

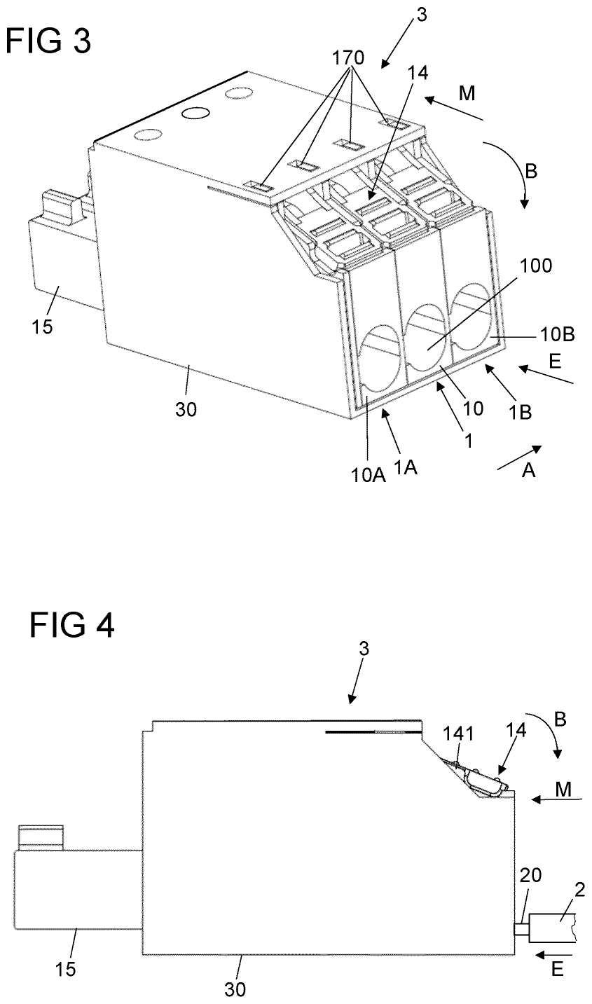

To assemble the connection assembly 3, the housing parts 10, 10A, 10B are inserted into the outer housing 3 in a position arranged in a row in an assembly direction M, in order to in this way enclose the connection terminals 1, 1A, 1B in the outer housing 30, as can be seen from FIGS. 1 and 3.

On the wall 105 of the housing parts 10, 10A, 10B, locking lugs 170, 171 protrude from the wall 105 at an upper edge and at a lower edge. In the assembled position, the locking lugs 170, 171 engage in associated locking openings on the outer housing 30, as can be seen from FIG. 1 for the locking lug 170.

On the wall 105 of the housing parts 10, 10A, a locking element 108′in the form of a spring tongue is formed rearwards, which tongue engages with an associated locking opening 108 on an adjacent housing part 10, 10A, 10B when the housing parts 10, 10A, 10B are attached, so that the housing parts 10, 10A, 10B are pre-assembled on one another and held together in a locking manner when attached along the row direction A. After inserting the pre-assembled assembly thus created into the outer housing 30, the connection assembly 3 is assembled and is mechanically stable due to the enclosure of the outer housing 30.

In the illustrated exemplary embodiment, each connection terminal 1, 1A, 1B is assigned a plug connector portion 15 which is formed on the outer housing 30 and in which a contacting device 111 of the correspondingly assigned contact element 11 is located.

The concept upon which the invention is based is not limited to the exemplary embodiment described above, but can also be realized in another way.

While, in the exemplary embodiment described above, all connection terminals of the connection assembly are implemented by a functionally identical spring-loaded connection, this is not mandatory. The connection terminals of the connection assembly can also differ from one another in terms of their function and design.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1, 1A, 1B, 1B Connection terminal
10, 10A, 10B Housing part
100 Insertion opening
101 Receiving space
102 Actuating opening
103, 103′Connection device
104, 104′Form-fitting element
105 Wall
106 Wall portion
107 Engagement opening
108, 108′Locking element
109 Bearing opening
109′Axle element
11 Contact element (current bar)
110 Contact portion
111 Contacting device
12 Clamping spring
120 Clamping leg
121 Supporting leg
122 Intermediate portion
13 Detachment element
130 Detachment leg
131 Locking element (Locking opening)
132 Supporting end
133 Run-on element
134, 135 Form-fitting element (recess)
136 Intermediate portion
137 Leg portion
138 End
14 Actuation element
140 Axle element
141 Actuating portion
142 Opening
143 Locking portion
144 Body portion (active portion)
145 Body portion (bearing portion)
146 Rear wall
147 Sliding face
148 Recess
149 Receiving slot
15 Plug connector portion
16 Sliding face
160 Housing portion
170, 171 Locking element
3 Connection assembly
30 Outer housing
A Row direction
B Actuation direction
E Insertion direction
M Assembly direction
R Radius
S Pivot axis
V Vertical direction

1. A connection terminal for connecting an electrical wire comprising:
a housing part;
a contact element arranged on the housing part, the contact element having a contact portion configured to electrically contact the electrical wire;
a spring element having has a clamping leg that is adjustable relative to the housing part, the clamping leg being configured to act on the electrical wire in a clamping position for contact with the contact portion; and
an actuation element arranged on the housing part so as to be pivotable about a pivot axis, the actuation element being pivotable from an unactuated position into an actuated position, so as to adjust the clamping leg from the clamping position,
wherein the actuation element has a first sliding face formed on a body portion of the actuation element, and
wherein the housing part has a second sliding face formed on a housing portion, the second sliding face being configured to slidingly support the first sliding face upon pivoting of the actuation element about the pivot axis.

2. The connection terminal of claim 1, wherein the first sliding face and/or the second sliding face are curved about the pivot axis.

3. The connection terminal of claim 1, wherein the first sliding face and/or the second sliding face have a constant radius of curvature about the pivot axis.

4. The connection terminal of claim 1, wherein the body portion of the actuation element comprises an active portion configured to act on the clamping leg upon pivoting of the actuation element.

5. The connection terminal of claim 1, wherein the first sliding face rests against the second sliding face in the unactuated position and in the actuated position of the actuation element, and upon pivoting of the actuation element pivots about the pivot axis between the unactuated position and the actuated position.

6. The connection terminal of claim 1, wherein the actuation element has a further, second body portion, and
wherein the clamping leg is received in a receiving slot between the body portion and the further, second body portion.

7. The connection terminal of claim 1, wherein the first sliding face is formed on an outer side of the body portion pointing radially outward to the pivot axis.

8. The connection terminal of claim 1, wherein the first sliding face is arranged on a side of the clamping leg facing away from the pivot axis.

9. The connection terminal of claim 1, wherein the housing portion of the housing part forms an insertion opening for insertion of an electrical wire.

10. The connection terminal of claim 1, wherein the clamping portion is configured to push or pull the electrical wire into abutment with the contact element by spring force.

11. The connection terminal of claim 1, wherein the spring element has a support leg via which the spring element is supported on the housing part.

12. The connection terminal of claim 11, wherein the spring element has a curved connecting portion arranged between the clamping leg and the support leg, the-curved connecting portion extending around the pivot axis.

13. The connection terminal of claim 1, wherein the clamping leg in a release position is, compared to the clamping position, removed from the contact portion, and
wherein the clamping leg in the release position is held in position relative to the housing part.

14. The connection terminal of claim 13, further comprising:
a detachment element configured to interact with the electrical wire, upon plugging of the electrical wire into the connection terminal, so as to detach the clamping leg from the release position.

15. The connection terminal of claim 14, wherein the detachment element has a detachment leg
wherein the housing part of the connection terminal defines a receiving space into which the electrical wire is insertable by plugging into the connection terminal, and
wherein the detachment leg extends in the receiving space for interaction with the electrical wire.

16. The connection terminal of claim 15, wherein the detachment element has a support end which is supported on the housing part, and
wherein the detachment leg is elastically adjustable relative to the support end by cooperation with the electrical wire upon plugging the electrical wire into the connection terminal.

17. A connection assembly, comprising:
a plurality of the connection terminal of housing parts of the connection terminals being arranged in a row along a row direction;
an outer housing into which the housing parts of the connection terminals arranged in a row along the row direction can be are insertable in an assembly direction, and in which the housing parts of the connection terminals arranged in the row along the row direction are received in an assembled position.
